(19) United States
(12) Patent Application Publication
(10) Pub. No.: US 2026/0095740 A1
(43) Pub. Date: Apr. 2, 2026

(54) ENHANCING ROAMING PERFORMANCE WITH MULTI-LINK OPERATION

(71) Applicant: Cisco Technology, Inc., San Jose, CA (US)

(72) Inventors: Malcolm Smith, Richardson, TX (US); Brian Hart, Sunnyvale, CA (US); Matthew S. MacPherson, Cary, NC (US); Binita Gupta, San Diego, CA (US)

(21) Appl. No.: 19/045,359

(22) Filed: Feb. 4, 2025

Related U.S. Application Data
(60) Provisional application No. 63/702,519, filed on Oct. 2, 2024.

(51) Int. Cl. H04W 8/02; H04W 48/16

(52) U.S. Cl. CPC H04W 8/02; H04W 48/16

(57) ABSTRACT

Existing roaming management strategies may lead to inconsistent performance causing disruptions during scanning. To address this, devices, systems, methods, and processes for facilitating enhancing roaming performance with multi-link operation are described herein. A non-access point (non-AP) multi-link device (MLD) associates, with an AP over a first link using a first set of radio resources and a second link using a second set of radio resources. The non-AP MLD further receives roaming assistance information about neighbor APs of the AP and determines time intervals for scanning for roaming candidate APs. The non-AP MLD indicates to the AP that the second link is unavailable and scans for the roaming candidate APs using the second set of radio resources of the second link, while having the first link operational with the AP to exchange the traffic. The non-AP MLD thus ensures seamless handoff and uninterrupted connectivity even before a reactive scan is triggered.

### CROSS-REFERENCE TO RELATED APPLICATIONS

This application claims priority and the benefit of U.S. Provisional Application No. 63/702,519, filed Oct. 2, 2024, the entirety of which is incorporated herein by reference.

### FIELD

The present disclosure relates to wireless communication networks. More particularly, the present disclosure relates to enhancing roaming performance with multi-link operation.

### BACKGROUND

Wi-Fi technology has evolved to incorporate advanced features that significantly reduce roaming times, sometimes achieving latencies as low as 10 milliseconds (ms) under optimal conditions. This is possible when a station (STA) and an access point (AP) operate on the same Basic Service Set (BSS) channel and are fully capable of transmitting and receiving management, control, and data frames. These advancements make modern wireless systems highly suitable for applications requiring low-latency connections, such as industrial Internet of Things (IoT) or certain real-time/near real-time communications. Additionally, improved mechanisms for load balancing, efficient channel utilization, and enhanced device management contribute to boosting overall network performance.

However, current wireless technology faces notable challenges, especially in scenarios where the STA has to perform off-channel scans for handoff. This process can considerably increase roaming times, often reaching 200-500 ms or more. The interference between scanning and ongoing data transmission may lead to inconsistent roaming performance, making it less suitable for applications that require seamless handoff, such as augmented reality (AR), virtual reality (VR), extended reality (XR), or other industrial internet of things (IoT) systems. Additionally, existing wireless systems face challenges in achieving seamless coordination between the STA and infrastructure to optimize roaming times across multiple channels. While advancements such as Multi-Link Device (MLD) architecture hold potential for improvement, these features are still not fully operational and depend on complex infrastructure synchronization.

### SUMMARY OF THE DISCLOSURE

Systems and methods for enhancing roaming performance with multi-link operation in accordance with embodiments of the disclosure are described herein. In many embodiments, a multi-link device comprises a processor and a memory. The memory is coupled to the processor and comprises a roaming management logic that is configured to associate, with an access point (AP) over a first link using a first set of radio resources and a second link using a second set of radio resources, exchange traffic with the AP over the first link, indicate to the AP that the second link is unavailable, and scan, upon indicating to the AP that the second link is unavailable, for a roaming candidate AP using the second set of radio resources of the second link, while having the first link operational with the AP to exchange the traffic.

In a variety of embodiments, the roaming management logic is further configured to receive roaming assistance information from the AP over at least one of the first link or the second link. The roaming assistance information indicates at least one neighbor AP of the AP.

In a number of embodiments, the roaming management logic is further configured to scan for the roaming candidate AP, using the second set of radio resources of the second link,, based on the roaming assistance information.

In further embodiments, the roaming assistance information comprises at least one of a neighbor report, a reduced neighbor report, or a link measurement report.

In additional embodiments, at least one power the roaming assistance information is received in one or more information elements of a wireless frame.

In more embodiments, the wireless frame is a beacon frame.

In numerous embodiments, the wireless frame is a probe response frame.

In several embodiments, the wireless frame comprises at least one of a Basic Service Set (BSS) Transition Management (BTM) request frame or a link reconfiguration notify frame.

In various embodiments, at least one information element of the one or more information elements is configured to indicate a beacon transmission time of the at least one neighbor AP.

In one or more embodiments, the beacon transmission time comprises a Target Beacon Transmission Time (TBTT) offset of the at least one neighbor AP.

In yet more embodiments, the roaming management logic is further configured to determine, based on the beacon transmission time, at least one time interval for roaming candidate scanning.

In still more embodiments, the roaming management logic is further configured to scan for the roaming candidate AP, using the second set of radio resources of the second link, during the determined at least one time interval.

In still yet more embodiments the roaming management logic is further configured to receive, based on the scanning, beacon information from the roaming candidate AP.

In many further embodiments, the roaming management logic is further configured to transition an association from the AP to the roaming candidate AP based on the received beacon information.

In one or more embodiments, indicating to the AP that the second link is unavailable comprises indicating to the AP that the second link is in a power save mode.

In several more embodiments, a multi-link device comprises a multi-link communication interface, a processor, and a memory communicatively coupled to the processor. The multi-link communication interface comprises a first set of radio resources and a second set of radio resources. The memory comprises roaming management logic that is configured to associate with an access point (AP) over a first link using the first set of radio resources and a second link using the second set of radio resources, exchange traffic with the AP over the first link, indicate to the AP that the second link is unavailable, and scan, upon indicating to the AP that the second link is unavailable, for a roaming candidate AP using the second set of radio resources of the second link, while concurrently having the first link operational with the AP to exchange the traffic.

In many additional embodiments, a method for roaming by a multi-link device, the method comprising associating with an access point (AP) over a first link using a first set of radio resources and a second link using a second set of radio resources, exchanging traffic with the AP over the first link, indicating to the AP that the second link is in a power save mode, and scanning, upon indicating to the AP that the second link is in the power save mode, for a roaming candidate AP using the second set of radio resources of the second link, while having the first link operational with the AP to exchange the traffic.

In many more embodiments, the method further comprises receiving roaming assistance information, indicating at least one neighbor AP of the AP, from the AP over at least one of the first link or the second link. The scanning for the roaming candidate AP using the second set of radio resources is based on the roaming assistance information.

In several additional embodiments, the method further comprises determining, based on the roaming assistance information, at least one time interval for roaming candidate scanning.

In numerous additional embodiments, scanning for the roaming candidate AP, using the second set of radio resources of the second link, occurs during the determined at least one time interval.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a schematic block diagram of a wireless local networking system in accordance with various embodiments of the disclosure;

FIG. 2 is a conceptual depiction of a communication layer architecture in accordance with various embodiments of the disclosure;

FIG. 3 is a conceptual network diagram of various environments in which a roaming management logic may operate in accordance with various embodiments of the disclosure;

FIG. 4 is a conceptual block diagram of a network architecture implementing multi-link operation for enhanced roaming performance in accordance with various embodiments of the disclosure.

FIG. 5 illustrates a flowchart depicting a process for enhancing roaming performance with multi-link operation in accordance with various embodiments of the disclosure;

FIG. 6 is a flowchart depicting a process for enhancing roaming performance with multi-link operation in accordance with various embodiments of the disclosure;

FIG. 7 is a flowchart depicting a process for enhancing roaming performance with multi-link operation in accordance with various embodiments of the disclosure;

FIG. 8 is a flowchart depicting a process for multi-link scanning for roaming candidate access points (APs) in accordance with various embodiments of the disclosure; and

FIG. 9 is a conceptual block diagram of a device suitable for configuration with a power management logic in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein to enhance roaming performance with multi-link operation. Wi-Fi 6 incorporates various advanced features such as 802.11k/vr to minimize roaming times, sometimes achieving latencies as low as 10 milliseconds (ms) under ideal conditions. This is achieved when both station (STA) and access point (AP) operate on the same Basic Service Set (BSS) channel, and transmit and receive management, control, and data frames effectively. These advancements make modern wireless systems well-suited for applications requiring low-latency connectivity, such as industrial Internet of Things (IoT) and real-time/near real-time communications. Additionally, improved mechanisms for load balancing, efficient channel utilization, and enhanced device management contribute to better overall network performance.

However, current wireless technology encounters notable challenges, particularly during off-channel scans for STA handoffs. Such off-channel scans significantly prolong roaming times, often exceeding 200-500 ms, due to the disruption caused by scanning during ongoing data transmission. Moreover, existing wireless systems fall short of facilitating effective STA and infrastructure coordination to optimize roaming across multiple channels. Specifically, the problem of Wi-Fi inoperability arises during channel scanning when single-radio STAs utilize the same hardware or resources for both active data communications and auxiliary operations such as Bluetooth operations or scanning for alternative APs. This overlap disrupts active connections and may result in performance degradation. In the absence of a secondary operational link to serve as a failover, devices are susceptible to temporary service interruptions or compromised performance during scanning intervals. Though Multi-Link Device (MLD) capabilities address this limitation by enabling multiple associated links to operate either independently or cooperatively. However, existing implementations do not explicitly define or support mechanisms for separating the transmission of Media Access Control (MAC) Protocol Data Units (MPDUs) on one link while simultaneously performing roaming-related scans using resources of another link.

The MLD architecture, which supports multiple links, offers the potential for “serve and scan” operation, where a primary link can maintain active communication while radio resources corresponding to a secondary link can be utilized for performing scanning. However, there are significant challenges related to this approach. For example, if “serve and scan” is implemented, the secondary link may remain unavailable for active use during scanning, making the secondary link ineffective as a backup in cases where the primary link, such as one operating on a 5 Gigahertz (GHz) or 6 GHz band, experiences unexpected channel degradation. This may create a vulnerability, as the secondary link cannot provide failover support when the primary link encounters interference, congestion, or other issues. Additionally, current MLD implementations lack proactive mechanisms to address link degradation, relying instead on reactive approaches. Under such circumstances, the STA triggers a scan only after significant link degradation occurs. This reactive approach may fail to identify a suitable alternative AP in time, leading to service interruptions. These challenges may undermine the seamless handoff experience required for latency-sensitive applications like augmented reality (AR), virtual reality (VR), and industrial IoT systems, where uninterrupted connectivity is paramount.

Thus, the present disclosure provides a solution that allows an STA with MLD capabilities (also referred to as “STA MLD” or “non-AP MLD”) to perform seamless handoff and provide uninterrupted connectivity by utilizing “serve and scan” before a reactive scan is triggered due to link degradation. During serve and scan, the non-AP MLD is configured to maintain active data transmission on one or more links (e.g., a first link) while using radio resources of another link (e.g., a second link) to perform opportunistic scanning for better roaming candidate APs. Examples of the non-AP MLD may include smartphones, laptops, IoT devices, wearables, or the like which support simultaneous multi-link or multi-channel operations for enhanced performance. In other words, the non-AP MLD may refer to an electronic device that supports simultaneous wireless communication across multiple links or frequency bands to provide seamless connectivity, throughput, and reliability. The non-AP MLD may operate on different channels or bands concurrently, optimizing data transmission, reducing latency, and providing more robust network performance by dynamically balancing traffic across available links. Non-AP MLDs may be broadly classified into multi-link multi-radio (MLMR) devices, which have multiple radio resources for concurrent operations on different links, and multi-link single-radio (MLSR) devices, which use a single radio to switch between links. The MLMR devices can transmit and receive data over multiple wireless channels concurrently. For example, an MLMR device may use one radio (e.g., resource) to communicate on a 2.4 GHz band and another on a 5 GHz or 6 GHz band, balancing traffic across these links. In contrast, the MLSR devices have only one physical radio capable of dynamically switching between different links or frequency bands. The MLSR devices can connect to multiple wireless links but can only use one at a time, relying on fast switching to manage communication across links.

In many embodiments, the non-AP MLD may include a processor and a memory communicatively coupled to the processor. The memory may include a roaming management logic that allows the non-AP MLD to serve and scan before triggering a reactive scan due to link degradation. In further embodiments, the roaming management logic can also be external to the non-AP MLD or may be embodied as a standalone device within the non-AP MLD.

In a number of embodiments, the non-AP MLD may be configured to associate with an AP over a first link using a first set of radio resources and a second link using a second set of radio resources. The non-AP MLD may further exchange traffic with the AP over the first link. In a variety of embodiments, the non-AP MLD may further receive roaming assistance information from the AP over at least one of the first link or the second link. The roaming assistance information may provide non-AP MLDs with network guidance, such as preferred APs for roaming or roaming candidate APs, channels, or bands, to enable faster and more efficient transitions between APs during roaming. In many examples, the roaming assistance information may include a neighbor report including one or more neighbor report elements, a reduced neighbor report, or a link measurement report. The neighbor report response may provide the non-AP MLD with detailed information about nearby APs, including their capabilities, operating channels, and load, to facilitate efficient roaming decisions. Further, RNR may refer to a compact set of information elements in Wi-Fi that provide details about nearby APs. These information elements may assist STAs in discovering potential connections efficiently by listing key parameters such as Service Set Identifiers (SSIDs), operating bands, and channel information. Further, the link measurement report may be useful as roaming assistance as it can provide detailed metrics about the current wireless link quality, such as signal strength and noise levels, to assist in network roaming optimization. In yet more embodiments, the roaming assistance information may be transmitted by the AP to the non-AP MLD via a wireless frame. The wireless frame may be any one of a beacon frame or a probe response frame. Further, the wireless frame can be a Basic Service Set (BSS) Transition Management (BTM) request frame sent by the AP or a link reconfiguration notify frame from the AP, or any other frame including neighbor report (sub)element(s). The BTM request frame may enable the current AP to guide the non-AP MLD towards better APs for improved connectivity, offering suggestions based on network conditions and STA performance. The link reconfiguration notify frame may refer to a message from the AP to the non-AP MLD, providing link level recommendations for one or more neighboring APs for optimizing roaming. In one or more embodiments, the roaming assistance information may indicate at least one neighbor AP of the AP associated with the non-AP MLD.

In additional embodiments, at least one information element of the one or more information elements in the roaming assistance information transmitted by the AP may be configured to indicate a beacon transmission time of the at least one neighbor AP. The beacon transmission time may include a Target Beacon Transmission Time (TBTT) offset of the at least one neighbor AP. The TBTT offset may refer to the time difference between the current AP's beacon transmission and a roaming candidate AP's beacon transmission. The non-AP MLD may determine, based on the beacon transmission time, at least one time interval for roaming candidate scanning. The at least time interval may be scheduled proactively, occurring well in advance of any potential reactive scan.

In still additional embodiments, the non-AP MLD may be configured to indicate to the AP that the second link is unavailable, for example, is in power save mode, and then scan for a roaming candidate AP utilizing the second set of radio resources of the second link, while having the first link operational with the AP to exchange the traffic. That is to say, the non-AP MLD, upon indicating to the AP that the second link is unavailable, for example, is in the power save mode, may scan for the roaming candidate AP using the second set of radio resources of the second link during the determined at least one time interval. Based on the scanning, the non-AP MLD may receive, beacon information from the roaming candidate AP. In further embodiments, the non-AP MLD may transition the association from the AP to the roaming candidate AP based on the received beacon information. Accordingly, the non-AP MLD may utilize the roaming assistance information to proactively coordinate scans for better roaming candidate APs at time intervals well before a reactive scan is required. This allows smoother handoffs and prevents link disconnects, ensuring continuous and reliable connectivity.

In still further embodiments, the non-AP MLD may be equipped with a multi-link communication interface. The multi-link communication interface may include hardware circuit comprising custom circuits or gate arrays, off-the-shelf semiconductors such as logic chips, transistors, or other discrete components that allows Wi-Fi enabled devices to simultaneously establish and manage connections across multiple frequency bands or links, enhancing throughput, reliability, and latency performance. For example, the multi-link communication interface may include the first set of radio resources and the second set of radio resources. In numerous embodiments, the non-AP MLD may associate with the AP over the first link using the first set of radio resources and the second link using the second set of radio resources, and exchange traffic with the AP over the first link. The non-AP MLD may further indicate to the AP that the second link is in the power save mode and scan for the roaming candidate AP using the second set of radio resources of the second link, while concurrently having the first link operational to exchange the traffic with the AP.

The non-AP MLDs may offer several advantages by enabling simultaneous communication across multiple frequency bands or links. In a non-AP MLD having two operable links may introduce a more deterministic approach to roaming. The non-AP MLD can proactively coordinate scans for better APs well before the need arises, leveraging roaming assistance information from the AP, such as RNR elements, neighbor report response frames, neighbor report elements, or the like. The serve and scan may further eliminate disruptions by offloading the scanning task to the secondary link, allowing the primary link to continue serving traffic uninterrupted. This may allow smoother handoffs and prevent link disconnects, ensuring continuous and reliable connectivity. This behavior may be particularly beneficial in dynamic environments with mobile users or varying network conditions. By enabling continuous data exchange and proactive scanning, the non-AP MLD can identify and transition to better APs at optimal times, ensuring consistent performance and improving user experience in latency-sensitive applications like video streaming, gaming, and industrial IoT.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.”. Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C #, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit. Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more”unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data. Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.”. An exception to this definition will occur only when a combination of elements, functions, steps, or acts are in some way inherently mutually exclusive.

Aspects of the present disclosure are described below with reference to schematic flowchart diagrams /d/ or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

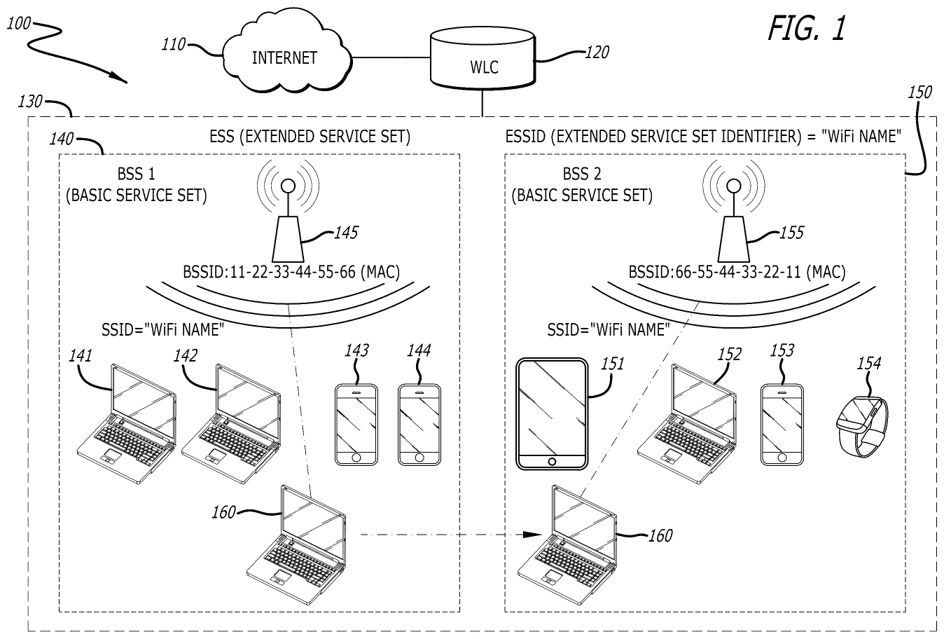

Referring to FIG. 1, a schematic block diagram of a wireless local networking system 100 in accordance with various embodiments of the disclosure is shown. Wireless local networking standards play an important role in enabling seamless communication and connectivity between various devices within localized areas. One of the most prevalent standards is Wi-Fi, which is based on the IEEE 802.11 family of protocols. Wi-Fi provides high-speed wireless access to the internet and local network resources, with iterations such as 802.11a, 802.11b, 802.11g, 802.11n, 802.11ac, and 802.11ax, each offering improvements in speed, range, and efficiency. The 802.11b (also referred to as 802.11 High Rate or Wi-Fi) provides 11 Mbps transmission (with a fallback to 5.5, 2, and 1 Mbps) in the 2.4 GHz band. Each adoption of Wi-Fi standards is often designed to bring enhanced performance, increased capacity, and better efficiency in crowded network environments. Other standards can commonly be used for short-range wireless communication between devices, particularly in the realm of personal area networks (PANs). Both Wi-Fi and other protocols have become integral components of modern connectivity, supporting a wide range of devices and applications across homes, businesses, and public spaces. Emerging technologies and future iterations continue to refine wireless networking standards, ensuring the evolution of efficient, reliable, and secure wireless communication.

In the realm of IEEE 802.11 wireless local area networking standards, commonly associated with Wi-Fi technology, a service set plays a pivotal role in defining and organizing wireless network devices. A service set essentially refers to a collection of wireless devices that share a common service set identifier (SSID). The SSID, often recognizable to users as the network name presented in natural language, serves as a means of identification and differentiation among various wireless networks. Within a service set, the nodes comprising devices like laptops, smartphones, or other Wi-Fi-enabled devices operate collaboratively, adhering to shared link-layer networking parameters. These parameters encompass specific communication settings and protocols that facilitate seamless interaction among the devices within the service set. Essentially, a service set forms a cohesive and logical network segment, creating an organized structure for wireless communication where devices can communicate and share data within the defined parameters, enhancing the efficiency and coordination of wireless networking operations.

In the context of wireless local area networking standards, a service can be configured in two distinct forms: a Basic Service Set (BSS) or an Extended Service Set (ESS). A basic service set represents a subset within a service set, comprised of devices that share common physical-layer medium access characteristics. These characteristics include parameters such as radio frequency, modulation scheme, and security settings, ensuring seamless wireless networking among the devices. The basic service set is uniquely identified by a Basic Service Set Identifier (BSSID), a 48-bit label adhering to MAC-48 conventions. Despite the possibility of a device having multiple BSSIDs, each BSSID is typically associated with, at most, one basic service set at any given time.

It's important to note that a basic service set should not be confused with the coverage area of an access point, which is referred to as the basic service area (BSA). The BSA encompasses the physical space within which an access point provides wireless coverage, while the basic service set focuses on the logical grouping of devices sharing common networking characteristics. This distinction emphasizes that the basic service set is a conceptual grouping based on shared communication parameters, while the basic service area defines the spatial extent of an access point's wireless reach. Understanding these distinctions is fundamental for effectively configuring and managing wireless networks, ensuring optimal performance and coordination among connected devices.

The service set identifier (SSID) defines a service set or extends a service set. Normally it is transmitted in the clear by stations in beacon packets to announce the presence of a network and seen by users as a wireless network name. Unlike basic service set identifiers, SSIDs are usually customizable. Since the contents of an SSID field are arbitrary, the 802.11 standard permits devices to advertise the presence of a wireless network with beacon packets. A station may also likewise transmit packets in which the SSID field is set to null; this prompts an associated access point to send the station a list of supported SSIDs. Once a device has been associated with a basic service set, for efficiency, the SSID is not sent within packet headers; only BSSIDs are used for addressing.

An extended service set (ESS) is a more sophisticated wireless network architecture designed to provide seamless coverage across a larger area, typically spanning environments such as homes or offices that may be too expansive for reliable coverage by a single access point. This network is created through the collaboration of multiple access points, presenting itself to users as a unified and continuous network experience. The extended service set operates by integrating one or more infrastructure basic service sets (BSS) within a common logical network segment, characterized by sharing the same IP subnet and VLAN (Virtual Local Area Network).

The concept of an extended service set is particularly advantageous in scenarios where a single access point cannot adequately cover the entire desired area. By employing multiple access points strategically, users can move seamlessly across the extended service set without experiencing disruptions in connectivity. This is crucial for maintaining a consistent wireless experience in larger spaces, where users may transition between different physical locations covered by distinct access points.

Moreover, extended service sets offer additional functionalities, such as distribution services and centralized authentication. The distribution services facilitate the efficient distribution of network resources and services across the entire extended service set. Centralized authentication enhances security and simplifies access control by allowing users to authenticate once for access to any part of the extended service set, streamlining the user experience and network management. Overall, extended service sets provide a scalable and robust solution for ensuring reliable and comprehensive wireless connectivity in diverse and expansive environments.

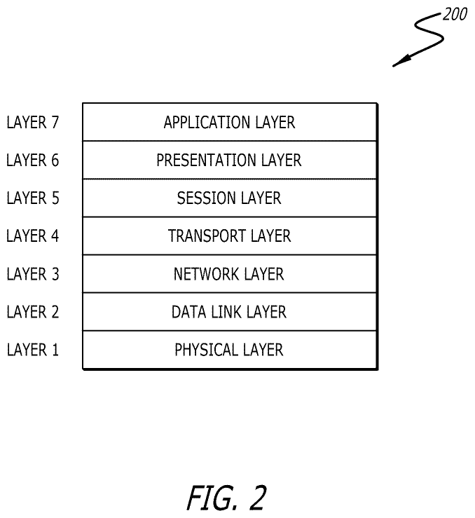

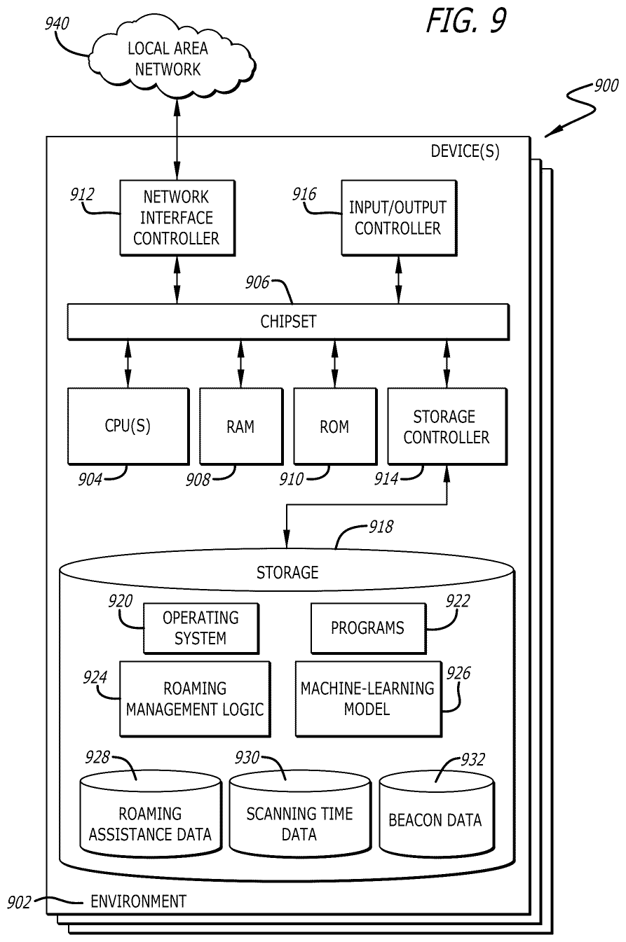

The network can include a variety of user end devices that connect to the network. These devices can sometimes be referred to as stations (i.e., “STAs”). Each device is typically configured with a medium access control (“MAC”) address in accordance with the IEEE 802.11 standard. The STAs may be equipped with multi-link device (MLD) capabilities that can manage multiple links simultaneously or sequentially to optimize network performance. As described in more detail in FIG. 2, a physical layer can also be configured to communicate over the wireless medium as described in more detail of FIG. 9, various devices on a network can include components such as a processor, transceiver, a multi-link communication interface, etc. These components can be configured to process frames of data transmitted and/or received over the wireless network. Access points (“APs”) are wireless devices configured to provide access to user end devices to a larger network, such as the Internet 110.

In the embodiment depicted in FIG. 1, a wireless network controller 120 (shown as WLC) is connected to a public network such as the Internet 110. The wireless network controller 120 is in communication with an extended service set (ESS 130). The ESS 130 comprises two separate basic service sets (a first BSS 1 140 and a second BSS 2 150). The ESS 130, the first BSS 1 140, and the second BSS 2 150 all transmit and are configured with the same SSID “Wi-Fi Name”, which can be a BSSID for each of the first BSS 1 140 and the second BSS 2 150 as well as an ESSID for the ESS 130.

Within the first BSS 1 140, the network comprises a first notebook 141 (shown as “notebook1”), a second notebook 142 (shown as “notebook2”), a first phone 143 (shown as “phone1”) and a second phone 144 (shown as “phone2”), and a third notebook 160 (shown as “notebook3”). Each of these devices may have MLD capabilities and can associated with a first access point 145 to exchange traffic over one or more links. Likewise, in the second BSS 2 150, the network comprises a first tablet 151 (shown as “tablet1”), a fourth notebook 152 (shown as “notebook4”), a third phone 153 (shown as “phone3”), and a first watch 154 (shown as “watch1”). All of these devices may have MLD capabilities and can associated with a second access point 155 to exchange traffic over one or more links. The third notebook 160 is communicatively connected to both the first BSS 1 140 and the second BSS 2 150. In this setup, third notebook 160 can be seen to “roam” from the physical area serviced by the first BSS 1 140 and into the physical area serviced by the second BSS 2 150. The third notebook 160 may receive roaming assistance information from the first AP 145 about a neighbor AP associated with the second BSS 2 150. For example, the third notebook 160 may scan for the neighbor AP at a first-time interval determined based on the roaming assistance information and identify that the neighbor AP provides superior signal strength than the first AP 145. Hence, the third notebook 160 can be seen to “roam” from the physical area serviced by the first BSS 1 140 and into the physical area serviced by the second BSS 2 150.

Although a specific embodiment for the wireless local networking system 100 is described above with respect to FIG. 1, any of a variety of systems and/or processes may be utilized in accordance with embodiments of the disclosure. For example, the wireless local networking system 100 may be configured into any number of various network topologies including different types of interconnected devices and user devices. The elements depicted in FIG. 1 may also be interchangeable with other elements of FIG. 2-9 as required to realize a particularly desired embodiment.

Referring to FIG. 2, a conceptual depiction of a communication layer architecture 200 in accordance with various embodiments of the disclosure is shown. In many embodiments, the communication layer architecture 200 can be utilized to carry out various communications described or required herein. In still more embodiments, the communication layer architecture 200 can be configured as the open systems interconnection model, more commonly known as the OSI model. Likewise, the communication layer architecture 200 may have seven layers which may be implemented in accordance with the OSI model.

In the embodiment depicted in FIG. 2, the communication layer architecture 200 includes a first physical layer, which can serve as the foundational layer among the seven layers. It is responsible for the transmission and reception of raw, unstructured data bits over a physical medium, such as cables or wireless connections. At this layer, the focus is on the electrical, mechanical, and procedural characteristics of the hardware, including cables, connectors, and signaling. The primary goal is to establish a reliable and efficient means of physically transmitting data between devices. The physical layer doesn't concern itself with the meaning or interpretation of the data; instead, it concentrates on the fundamental aspects of transmitting binary information, addressing issues like voltage levels, data rates, and modulation techniques. Devices operating at the physical layer include network cables, connectors, repeaters, and hubs. The physical layer's successful operation is fundamental to the functioning of the entire OSI model, as it forms the bedrock upon which higher layers build their more complex communication protocols and structures.

In some embodiments, the communication layer architecture 200 can include a second data link layer which may be configured to be primarily concerned with the reliable and efficient transmission of data between directly connected devices over a particular physical medium. Its responsibilities include framing data into frames, addressing, error detection, and, in some cases, error correction. The data link layer is divided into two sublayers: Logical Link Control (LLC) and Media Access Control (MAC). The LLC sublayer manages flow control and error checking, while the MAC sublayer is responsible for addressing devices on the network and controlling access to the physical medium. Ethernet is a common example of a data link layer protocol. This layer ensures that data is transmitted without errors and manages the flow of frames between devices on the same local network. Bridges and switches operate at the data link layer, making forwarding decisions based on MAC addresses. Overall, the data link layer plays a crucial role in creating a reliable point-to-point or point-to-multipoint link for data transmission between neighboring network devices.

In various embodiments, the communication layer architecture 200 can include a third network layer which can be configured as a pivotal component responsible for the establishment of end-to-end communication across interconnected networks. Its primary functions include logical addressing, routing, and the fragmentation and reassembly of data packets. The network layer ensures that data is efficiently directed from the source to the destination, even when the devices are not directly connected. IP (Internet Protocol) is a prominent example of a network layer protocol. Devices known as routers operate at this layer, making decisions on the optimal path for data to traverse through a network based on logical addressing. The network layer abstracts the underlying physical and data link layers, allowing for a more scalable and flexible communication infrastructure. In essence, it provides the necessary mechanisms for devices in different network segments to communicate, contributing to the end-to-end connectivity that is fundamental to the functioning of the internet and other large-scale networks.

In additional embodiments, the fourth transport layer can be a critical element responsible for the end-to-end communication and reliable delivery of data between devices. Its primary objectives include error detection and correction, flow control, and segmentation and reassembly of data. Two key transport layer protocols are Transmission Control Protocol (TCP) and User Datagram Protocol (UDP). TCP ensures reliable and connection-oriented communication by establishing and maintaining a connection between sender and receiver, and it guarantees the orderly and error-free delivery of data through mechanisms like acknowledgment and retransmission. UDP, on the other hand, offers a connectionless and more lightweight approach suitable for applications where speed and real-time communication take precedence over reliability. The transport layer shields the upper-layer protocols from the complexities of the network and data link layers, providing a standardized interface for applications to send and receive data, making it a crucial facilitator for efficient, end-to-end communication in networked environments.

In further embodiments, a fifth session layer can be configured to play a pivotal role in managing and controlling communication sessions between applications. It provides mechanisms for establishing, maintaining, and terminating dialogues or connections between devices. The session layer helps synchronize data exchange, ensuring that information is sent and received in an orderly fashion. Additionally, it supports functions such as checkpointing, which allows for the recovery of data in the event of a connection failure, and dialog control, which manages the flow of information between applications. While the session layer is not as explicitly implemented as lower layers, its services are crucial for maintaining the integrity and coherence of data during interactions between applications. By managing the flow of data and establishing the context for communication sessions, the session layer contributes to the overall reliability and efficiency of data exchange in networked environments.

In still more embodiments, the communication layer architecture 200 can include a sixth presentation layer, which may focus on the representation and translation of data between the application layer and the lower layers of the network stack. It can deal with issues related to data format conversion, ensuring that information is presented in a standardized and understandable manner for both the sender and the receiver. The presentation layer is often responsible for tasks such as data encryption and compression, which enhance the security and efficiency of data transmission. By handling the transformation of data formats and character sets, the presentation layer facilitates seamless communication between applications running on different systems. This layer may then abstract the complexities of data representation, enabling applications to exchange information without worrying about differences in data formats. In essence, the presentation layer plays a crucial role in ensuring interoperability and data integrity between diverse systems and applications within a networked environment.

Finally, the communication layer architecture 200 can also comprise a seventh application layer which may serve as the interface between the network and the software applications that end-users interact with. It can provide a platform-independent environment for communication between diverse applications and ensures that data exchange is meaningful and understandable. The application layer can encompass a variety of protocols and services that support functions such as file transfers, email, remote login, and web browsing. It acts as a mediator, allowing different software applications to communicate seamlessly across a network. Some well-known application layer protocols include HTTP (Hypertext Transfer Protocol), FTP (File Transfer Protocol), and SMTP (Simple Mail Transfer Protocol). In essence, the application layer enables the development of network-aware applications by defining standard communication protocols and offering a set of services that facilitate robust and efficient end-to-end communication across networks.

Although a specific embodiment for a communication layer architecture 200 is described above with respect to FIG. 2, any of a variety of systems and/or processes may be utilized in accordance with the embodiments of the disclosure. For example, various aspects described herein may reside or be carried out on one layer, or a plurality of layers. The elements depicted in FIG. 2 may also be interchangeable with other elements of FIG. 1 and FIG. 3-9 as required to realize a particularly desired embodiment.

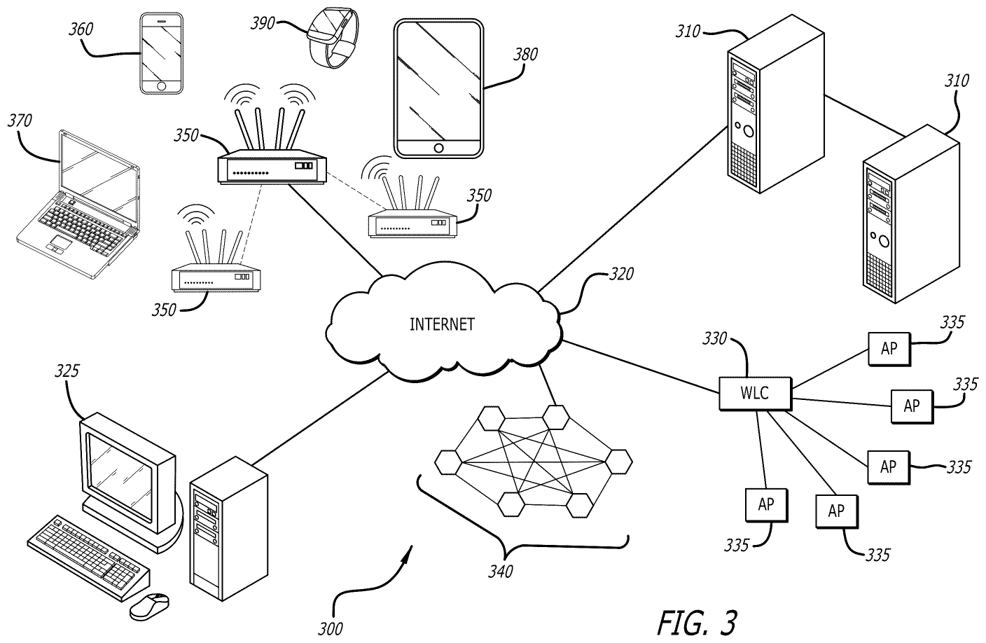

Referring to FIG. 3, a conceptual network diagram 300 of various environments in which a roaming management logic may operate in accordance with various embodiments of the disclosure is shown. Those skilled in the art will recognize that the roaming management logic can include various hardware and/or software deployments and can be configured in a variety of ways. In many embodiments, the roaming management logic can be configured as a standalone device, exist as a logic in another electronic device, be distributed among various electronic devices operating in tandem, or be remotely operated as part of a cloud-based network management tool. In further embodiments, one or more servers 310 can be configured with the roaming management logic or can otherwise operate as the roaming management logic. In many embodiments, the roaming management logic may operate on one or more servers 310 connected to a communication network 320 (shown as the “Internet”). The communication network 320 can include wired networks or wireless networks. The roaming management logic can be provided as a cloud-based service that can service remote networks, such as, but not limited to a deployed network 340.

In the embodiment depicted in FIG. 3, a plurality of network access points (APs) 350 may facilitate Wi-Fi connections for various STAs with MLD capabilities, such as but not limited to, mobile computing devices including laptop computers 370, cellular phones 360, portable tablet computers 380, and wearable computing devices 390. The STAs with MLD capabilities may also be referred to as “STA MLDs” or as “non-AP MLDs”. The non-AP MLDs may be client devices capable of simultaneously connecting to multiple Wi-Fi networks or links, enabling improved performance, redundancy, and flexibility. The non-AP MLDs can connect to both 2.4 GHz and 5 GHz bands, or even 6 GHz in Wi-Fi 6E and Wi-Fi 7 environments. The non-AP MLDs may use multiple radios, interfaces, or resources to maintain simultaneous connections. However, some non-AP MLDs may only use a single radio. In an example, a non-AP MLD may be equipped with a multi-link communication interface and integrated with a roaming management logic to manage handoffs between different APs 150 for seamless transitions without service disruption. The roaming management logic may dynamically select the best available link or network for the non-AP MLD, considering factors like signal strength, network load, and traffic demands.

In the embodiment depicted in FIG. 3, a wireless LAN controller (WLC) 330 may have an integrated networking logic that the WLC 330 can use to monitor or control APs 335 that the WLC 330 is connected to, either wired or wirelessly. In still more embodiments, a personal computer 325 may be utilized to access and/or manage various aspects of the roaming management logic, either remotely or within the network itself. In the embodiment depicted in FIG. 3, the personal computer 325 communicates over the communication network 320 and can access the roaming management logic of the servers 310, the non-AP MLDs, or the like. In still more embodiments, the roaming management logic may be integrated into laptop computers 370, cellular phones 360, portable tablet computers 380, and wearable computing devices 390.

Although a specific embodiment for various environments, in which a roaming management logic may operate, suitable for carrying out the various steps, processes, methods, and operations described herein is discussed with respect to FIG. 3, any of a variety of systems and/or processes may be utilized in accordance with embodiments of the disclosure. In many non-limiting examples, the roaming management logic may be provided as a device or software separate from the non-AP MLDs. The elements depicted in FIG. 3 may also be interchangeable with other elements of FIG. 1-2 and FIG. 4-9 as required to realize a particularly desired embodiment.

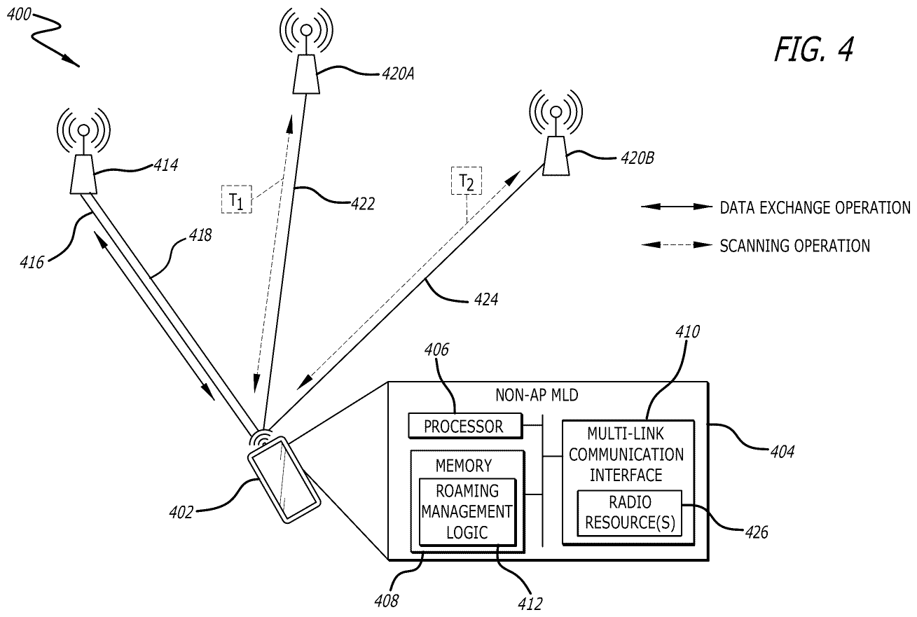

Referring to FIG. 4, a conceptual block diagram of a network architecture 400 implementing multi-link operation for enhanced roaming performance in accordance with various embodiments of the disclosure is shown. The network architecture 400 may include an STA 402 with MLD capabilities, which enable the STA 402 to manage multiple links simultaneously or sequentially to optimize network performance. Examples of the STA 402 may include Wi-Fi-enabled smartphones, laptops, wearables, gaming consoles, Internet of Things (IoT) devices, etc., which support simultaneous multi-band or multi-channel operations for enhanced performance.

In many embodiments, the MLD capabilities in the STA 402 may be facilitated by a non-AP MLD 404 equipped in the STA 402. In a variety of embodiments, the non-AP MLD 404 may include a processor 406, a memory 408, and a multi-link communication interface 410. The processor 406 may include suitable logic, circuitry, and interfaces that are configured to execute instructions stored in the memory 408. The processor 406 may correspond to an application-specific integrated circuit (ASIC) processor, a complex instruction set computing (CISC) processor, a central processing unit (CPU), an explicitly parallel instruction computing (EPIC) processor, a very long instruction word (VLIW) processor, and/or other processors or circuits. The memory 408 may comprise suitable logic, circuitry, and interfaces that are configured to store a machine code and/or the instructions executable by the processor 406. The memory 408 may correspond to random access memory (RAM), read only memory (ROM), electrically erasable programmable read-only memory (EEPROM), a hard disk drive (HDD), a solid-state drive (SSD), a CPU cache, and/or a secure digital (SD) card. The multi-link communication interface 410 may include a hardware circuit comprising custom VLSI circuits or gate arrays, off-the-shelf semiconductors such as logic chips, transistors, or other discrete components that allow the STA 402 to simultaneously establish and manage connections across multiple frequency bands or links, enhancing throughput, reliability, and latency performance. Examples of the multi-link communication interface 410 may include, but are not limited to, a multi-link multi-radio (MLMR) interface that utilizes multiple independent radios to connect to multiple links, a multi-link single-radio (MLSR) that uses a single radio to switch between various links, an enhanced MLSR (eMLSR), or the like. In the FIG. 4, the multi-link communication interface 410 is shown to include one or more radio resources 426. The radio resource(s) 426 may include a first set of radio resources and a second set of radio resources. For example, the radio resource(s) 426 may include a first radio transceiver and a second radio transceiver.

In a number of embodiments, the memory 408 may embody a roaming management logic 412. In several embodiments, the roaming management logic 412 may be configured to ensure seamless connectivity and efficient handoffs between APs. The roaming management logic 412 may proactively monitor link performance and evaluate roaming candidates using metrics such as signal strength, channel quality, and load. Though the roaming management logic 412 is shown to be included within the memory 408, the scope of the disclosure is not limited to it. In other embodiments, the roaming management logic 412 may be implemented as a standalone component within the non-AP MLD 404.

In various embodiments, the roaming management logic 412 may enable a deterministic approach to roaming. Traditional roaming processes often involve temporary disruptions to active data exchange as an STA may halt communication to scan for alternative APs. In contrast, the roaming management logic 412 may implement a “serve and scan” in which at least one link with a currently associated AP remains operational for exchanging traffic (e.g., for serving) while radio resources of another link (which may be indicated as temporarily unavailable to the AP) are utilized for scanning roaming candidate APs. In other words, the roaming management logic 412 may offload the scanning of roaming candidate APs to radio resources of a secondary link, while allowing a primary link established with an AP to remain operational and continue serving traffic in an uninterrupted manner. In more embodiments, the roaming management logic 412 may be configured to proactively coordinate scans for roaming candidate APs well before the need arises, for example, before the connection with the currently associated AP starts to degrade. Thus, the roaming management logic 412 may prevent triggering a reactive scan that forces the non-AP MLD 404 to scan for a new AP only when the connection with a currently associated AP begins to degrade. Instead, the roaming management logic 412 allows opportunistic scanning for better roaming candidate APs using radio resources of the secondary link.

In a number of embodiments, the non-AP MLD 404 may be configured to associate with an AP 414 (e.g., a reference AP, a main AP, a central AP, or the like) over one or more links by utilizing the multi-link communication interface 410. For example, the non-AP MLD 404 may associate with the AP 414 over the one or more links by utilizing the radio resource(s) 426 and one or more additional resources of the AP 414. In many embodiments, the one or more additional resources can include hardware resources and software resources. For example, the hardware resources may include antennas, network interface controllers, baseband processors, memory buffers, beamforming hardware, or the like. Further, examples of the software resources may include MAC layer resources, network layer resources, link management applications, channel access scheduling applications, load balancing applications, or the like. To associate with the AP 414, the non-AP MLD 404 may initiate a connection request to the AP 414. Next, the AP 414 and the non-AP MLD 404 may exchange capabilities, which include supported link parameters, multi-link operations, or the like. Based on this negotiation, the non-AP MLD 404 may select the one or more links to associate with the AP 414. Once the association is completed and the one or more links are established, the non-AP MLD 404 may begin communication (e.g., exchange traffic) with the AP 414 over the established multi-link connection. In the example embodiment shown in FIG. 4, the non-AP MLD 404 associates with the AP 414 over a first link 416 using the first set of radio resources in the radio resource(s) 426 and a second link 418 using the second set of radio resources in the radio resource(s) 426. Further, the non-AP MLD 404 exchanges traffic with the AP 414 over the first link 416. If required, for example, for bandwidth enhancement or maintaining QoS, the non-AP MLD 404 can additionally or alternatively exchange traffic with the AP 414 over the second link 418. The first link 416 may therefore act as a primary link that operates in a “serve” mode and the second link 418 may act as a secondary link to enhance the functionality of the primary link. In other words, the association between the AP 414 and the non-AP MLD 404 may occur over multiple links, with one link designated as the primary link (e.g., the first link 416) to handle control frames, management tasks, and essential traffic coordination, while other links (e.g., the second link 418) may serve as secondary links, providing additional bandwidth, improved performance, or acting as backups to maintain connectivity in case of primary link failure.

In a variety of embodiments, the non-AP MLD 404 may receive roaming assistance information from the AP 414 over at least one of the first link 416 or the second link 418. The roaming assistance information may provide the non-AP MLD 404 with network guidance, such as preferred APs for roaming (e.g., roaming candidate APs), channels, or bands, to enable faster and more efficient transitions between APs during roaming and to avoid reactive panic behavior. Accordingly, the roaming assistance information may include, for example, a neighbor report, a reduced neighbor report, or a link measurement report. A neighbor report may provide comprehensive details such as capabilities, operating channels, and load regarding one or more neighbor APs of the AP 414 to the non-AP MLD 404. Further, RNR may serve as a compact set of information elements in Wi-Fi that provide details, such as SSIDs, operating bands, and channel information of the neighbor APs. Further, the link measurement report may be useful as roaming assistance as it can provide detailed metrics about the current wireless link quality, such as signal strength and noise levels, to assist in network optimization. The roaming assistance information may assist the non-AP MLD 404 in proactively discovering potential roaming candidate APs. For example, the roaming assistance information may indicate at least one neighbor AP of the AP 414.

In yet more embodiments, the roaming assistance information may be received by the non-AP MLD 404 in one or more information elements of a wireless frame. For example, the AP 414 may transmit a wireless frame over the first link 416 to the non-AP MLD 404 to provide the roaming assistance information. The wireless frame can be a beacon frame or a probe response frame. In other words, the non-AP MLD 404 can receive the roaming assistance information from the AP 414 in a solicited manner or an unsolicited manner. In still more embodiments, the wireless frame can be a BSS Transition Management (BTM) request frame sent by the AP 414, a link reconfiguration notify frame from the AP 414, or any frame containing Neighbor Report (sub)element(s). The BTM request frame may enable the AP 414 to guide the non-AP MLD 404 towards better roaming candidate APs for improved connectivity, offering suggestions based on network conditions and STA performance. The link reconfiguration notify frame may refer to a message from the AP 414 to the non-AP MLD 404, providing link level recommendations for one or more neighboring APs for optimizing roaming.

Among the one or more information elements in the wireless frame, at least one information element may be configured to indicate beacon transmission times of the neighbor APs of the AP 414. In an example embodiment shown in FIG. 4, the AP 414 has two neighbor APs 420A and 420B. Thus, the at least one information element in the wireless frame transmitted by the AP 414 may indicate beacon transmission times of the neighbor APs 420A and 420B. In still more embodiments, beacon transmission times may include a Target Beacon Transmission Time (TBTT) offset of each neighbor AP. TBTT of a neighbor AP may indicate a time difference between a currently associated AP's beacon transmission and a neighbor AP's beacon transmission. For example, a first TBTT offset of the neighbor AP 420A may indicate the time difference between a beacon transmission of the AP 414 and a beacon transmission of the neighbor AP 420A. Likewise, a second TBTT offset of the neighbor AP 420B may indicate the time difference between a beacon transmission of the AP 414 and a beacon transmission of the neighbor AP 420B.

Using the beacon transmission time information, more specifically the TBTT offsets, the non-AP MLD 404 may determine one or more time intervals during which the non-AP MLD 404 can efficiently scan for roaming candidate APs. For example, using the first TBTT offset, the non-AP MLD 404 may determine at least one first time interval T₁ during which the non-AP MLD 404 can efficiently scan for the neighbor AP 420A. Likewise, using the second TBTT offset, the non-AP MLD 404 may determine at least one second time interval T₂ during which the non-AP MLD 404 can efficiently scan for the neighbor AP 420B.

In still additional embodiments, the non-AP MLD 404 may indicate to the AP 414 that the second link 418 is unavailable and scan for one or more roaming candidate APs utilizing the second set of radio resources of the second link 418, while having the first link 416 operational with the AP 414 to exchange the traffic. In other words, the non-AP MLD 404 may temporarily indicate to the AP 414 that the second link 418 is unavailable and then utilize the second set of radio resources in the scan mode to scan for the one or more roaming candidate APs. In one or more embodiments, indicating to the AP 414 that the second link 418 is unavailable may include indicating to the AP 414 that the second link 418 is in a power save mode. For example, the power save mode in a multi-link operation may allow the non-AP MLD 404 to temporarily reduce operation from multiple links to a reduced number of links (e.g., a single link) to conserve power. In such scenario, the non-AP MLD 404 may notify the AP 414 of such change in link operation, indicating temporary unavailability of specific links. In current example, the non-AP MLD 404 may indicate to the AP 414 that the second link 418 is unavailable due to the power save mode. In embodiments where the multi-link communication interface 410 corresponds to an MLMR interface, the non-AP MLD 404 may temporarily utilize the second set of radio resources of the second link 418 in the scan mode to scan for the one or more roaming candidate APs, while concurrently having the first set of radio resources operational for exchanging the traffic with the AP 414 over the first link 416.

In further embodiments, the non-AP MLD 404 may scan for the one or more roaming candidate APs, utilizing the second set of radio resources corresponding to or associated with the second link 418, based on the roaming assistance information. More specifically, the non-AP MLD 404 may utilize the received TBTT offset information to precisely schedule roaming candidate AP scans utilizing the second set of radio resources, aligning the roaming candidate AP scans with the beacon transmission times of the neighbor APs. For example, during the determined first time interval T₁, the non-AP MLD 404 may scan over a third link 422 for a first roaming candidate AP (e.g., the neighbor AP 420A) using the second set of radio resources. Similarly, during the determined second time interval T₂, the non-AP MLD 404 may scan over a fourth link 424 for a second roaming candidate AP (e.g., the neighbor AP 420B) using the second set of radio resources. In other words, the second link 418 may be indicated as unavailable, to the AP 414, to serve as the backup link for the first link 416 during the first time interval T₁ and the second time interval T₂. Thus, outside of the first time interval T₁ and the second time interval T₂, the second link 418 may remain available to serve as the backup link for traffic exchange with the AP 414. This approach ensures that the non-AP MLD 404 may perform the roaming candidate AP scans at optimal times to directly capture beacon transmissions, avoiding unnecessary waiting. While only two neighbor APs 420A and 420B are shown in FIG. 4, in an actual implementation there can be any number of neighbor APs.

In many additional embodiments, the second set of radio resources associated with the second link 418 can be utilized to scan the first and second roaming candidate APs across any channel or band. For example, if the second link 418 operates on the 5 GHz band, and the non-AP MLD 404 indicates (or signals) power saving mode for the second link 418 to the AP 414, the second set of radio resources associated with the second link 418 can be repurposed to perform scans on any 5 GHz channels or even channels in other frequency bands, such as the 6 GHz band, provided the second set of radio resources supports operation in those bands.

Based on the scanning during a determined time interval, the non-AP MLD 404 may receive beacon information from a roaming candidate AP. For example, the non-AP MLD 404 may receive first beacon information of the neighbor AP 420A during the first time interval T₁ and second beacon information of the neighbor AP 420B during the second time interval T₂. Based on the received beacon information, the non-AP MLD 404 may determine whether to transition association from the current AP 414 to a better-suited roaming candidate AP, for example, any of the neighbor APs 420A or 420B. For example, if the received first beacon information of the neighbor AP 420A indicates that the neighbor AP 420A provides a more stable connection than the AP 414, the non-AP MLD 404 may transition the association from the AP 414 to the roaming candidate AP such as the neighbor AP 420A. However, if the received first and second beacon information indicates that the neighbor APs 420A and 420B do not provide a better connection (e.g., higher signal quality) than the AP 414, the non-AP MLD 404 may continue the association with the AP 414. This precise timing of scans reduces the overall scanning duration since the non-AP MLD 404 may directly intercept beacons without extended waiting. Additionally, the need for active scanning via Probe Request/Response exchanges may be eliminated, significantly reducing scanning overhead. As a result, the second link 418 remains available to serve as the backup link for traffic exchange with the AP 414 for longer durations.

Although a specific embodiment for a network architecture implementing enhanced roaming performance with multi-link operation suitable for carrying out the various steps, processes, methods, and operations described herein is discussed with respect to FIG. 4, any of a variety of systems and/or processes may be utilized in accordance with embodiments of the disclosure. For example, the multi-link communication interface 410 may correspond to an MLSR interface or an eMLSR, with only one radio transceiver. In such embodiments, the non-AP MLD 404 may be configured to time-share between traffic exchange over the first link 416 and scanning without interrupting the association with the AP 414. Further, the non-AP MLD 404 may utilize the roaming assistance information to scan efficiently during low-traffic periods or when the link quality of the first link 416 is still good. The elements depicted in FIG. 4 may also be interchangeable with other elements of FIG. 1-3 and FIG. 5-9 as required to realize a particularly desired embodiment.

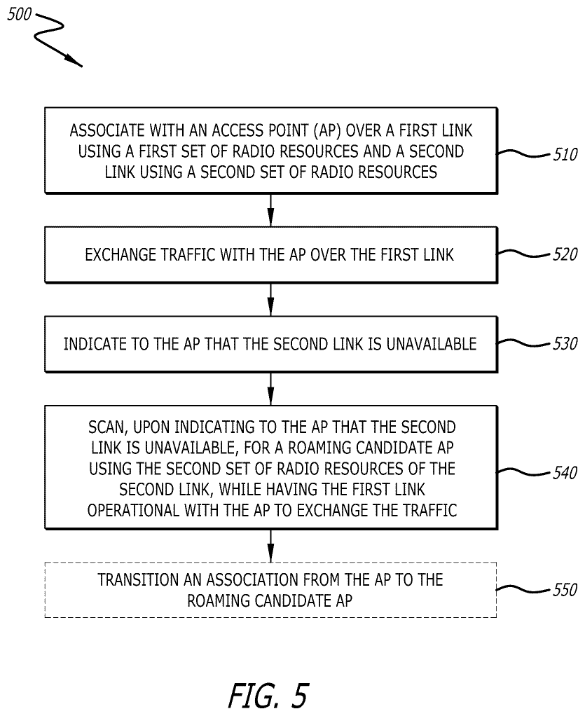

Referring to FIG. 5, a flowchart depicting a process 500 for enhancing roaming performance with multi-link operation in accordance with various embodiments of the disclosure is shown. Having disclosed a brief introductory description of exemplary systems and networks within FIG. 1-4, FIG. 5 depicts the process 500 that enhances roaming performance with multi-link operation to ensure seamless handoff and uninterrupted connectivity, for example, for latency-sensitive applications. The process 500 may be performed at a non-AP MLD (also referred to as an “STA MLD”). Non-AP MLDs may refer to client devices, such as smartphones, laptops, or IoT devices, that support multi-link operations but do not function as access points themselves. These devices use their MLD features to connect to APs across multiple links, optimizing connectivity and performance. In a number of embodiments, the process 500 may associate with an AP over a first link using a first set of radio resources and a second link using a second set of radio resources (block 510). In many embodiments, the first and second set of radio resources may include hardware and software resources. For example, the hardware resources may include radio transceivers, antennas, network interface controllers, baseband processors, memory buffers, beamforming hardware, or the like. Further, examples of the software resources may include MAC layer resources, network layer resources, link management applications, channel access scheduling applications, load balancing applications, or the like. The first link may be one of a plurality of links set up on an optimal frequency band, such as 2.4 GHz, 5 GHz, or 6 GHz, based on the AP's capabilities and MLD preferences. The first link may therefore act as a primary link that operates in a “serve” mode. In various embodiments, in a multi-link connection, association between the AP and the non-AP MLD may occur over multiple links, with one link designated as the primary link (e.g., the first link) to handle control frames, management tasks, and essential traffic coordination, while other links (e.g., the second link) may serve as secondary links, providing additional bandwidth, improved performance, or acting as backups to maintain connectivity in case of primary link failure.

In a number of embodiments, the process 500 may exchange traffic with the AP over the first link (block 520). The exchange of traffic may include activities such as transmitting and receiving traffic, streaming videos, accessing cloud services, or receiving roaming assistance information. The first link may thus serve as a primary channel for maintaining connectivity, ensuring stable and uninterrupted communication while the MLD is stationary or moving. During traffic exchange, if the primary link fails or experiences temporary degradation, the process 500 may utilize the second link to serve traffic. The process 500 can also utilize the second link to serve traffic to enhance the performance of the first link.

In one or more embodiments, the process 500 may indicate to the AP that the second link is unavailable (block 530). For example, if the process 500 detects a requirement to perform a scan for a roaming candidate AP, the process 500 may indicate to the AP that the second link is unavailable, and free up the second set of radio resources of the second link for such a scan. In an example, indicating to the AP that the second link is unavailable may include indicating to the AP that the second link is in a power save mode and is temporarily unavailable.

In several embodiments, the process 500 may scan, upon indicating to the AP that the second link is unavailable, for a roaming candidate AP using the second set of radio resources of the second link, while having the first link operational with AP to exchange the traffic (block 540). That is to say, while the first link continues to handle traffic, the second set of radio resources of the second link may be repurposed and temporarily utilized to scan for better roaming candidate APs. The process 500 may leverage multi-link capabilities, allowing the non-AP MLD to identify nearby APs with stronger signals, lower congestion, or better resources without disrupting ongoing data exchange on the first link. The scanning process may rely on mechanisms such as BTM request frames, link reconfiguration notify frames, link management reports, neighbor reports, reduced neighbor reports, or any frame containing neighbor report or RNR (sub)element(s) to target specific APs for faster discovery.

In numerous embodiments, the process 500 may transition an association from the AP to the roaming candidate AP (block 550). That is to say, if a better roaming candidate AP is identified during the scan, the process 500 may choose to transition the association of the non-AP MLD from the current AP to the better roaming candidate AP. The process 500 may disconnect from the old AP and establish a new connection with the better roaming candidate AP. The multi-link capabilities ensure that the transition is smooth, minimizing interruptions in connectivity or ongoing traffic. In further embodiments, this association from the AP to the roaming candidate AP may only occur when a superior candidate AP, for example, with better signal quality, is found.

Although specific embodiments for enhancing roaming performance with multi-link operation suitable for carrying out the various steps, processes, methods, and operations are described above with respect to FIG. 5, any of a variety of systems and/or processes may be utilized in accordance with embodiments of the disclosure. In a variety of embodiments, the process 500 may utilize a multi-link communication interface to associate with one or more APs by establishing connections with the one or more APs over multiple frequency links through a unified negotiation process, leveraging its multi-link capabilities. The elements depicted in FIG. 5 may also be interchangeable with other elements of FIG. 1-4 and FIG. 6-9 as required to realize a particularly desired embodiment.

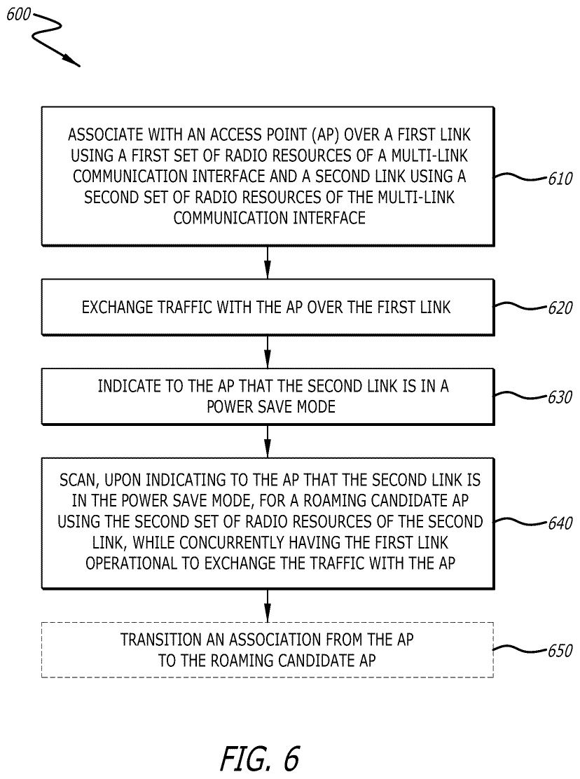

Referring to FIG. 6, a flowchart depicting a process for enhancing roaming performance with multi-link operation in accordance with various embodiments of the disclosure. The process 600 may be performed at a non-AP MLD. In an example, the non-AP MLD may include a multi-link communication interface, for example, an MLMR communication interface, for multi-link communication. The MLMR interface may enable true simultaneous communication on multiple links. Each radio transceiver can operate on a different frequency band or channel, allowing concurrent traffic exchange and scanning without interference.

In many embodiments, the process 600 may associate with an AP over a first link a using a first set of radio resources of the multi-link communication interface and a second link using second set of radio resources of the multi-link communication interface (block 610). In many embodiments, the first and second set of radio resources may include hardware and software resources. For example, the hardware resources may include radio transceivers, antennas, network interface controllers, baseband processors, memory buffers, beamforming hardware, or the like. Further, examples of the software resources may include MAC layer resources, network layer resources, link management applications, channel access scheduling applications, load balancing applications, or the like. The first link may be established based on factors such as signal strength, channel conditions, or band preference (e.g., 5 GHz or 6 GHz). In various embodiments, in a multi-link connection, association between the AP and the non-AP MLD may occur over multiple links, with one link designated as the primary link (e.g., the first link) to handle control frames, management tasks, and essential traffic coordination, while other links (e.g., the second link) may serve as secondary links, providing additional bandwidth, improved performance, or acting as backups to maintain connectivity in case of primary link failure.

In a variety of embodiments, the process 600 may exchange traffic with the AP over the first link (block 620). The exchange of traffic may include data exchange activities such as video streaming, browsing, real-time communication, or reception of roaming assistance information. An example of exchanging traffic with the AP over the first link is a smartphone streaming a high-definition video using its Wi-Fi connection. The first link of the smartphone may be connected to an AP on a 5 GHz band, that facilitates a continuous exchange of data packets for the video stream. The AP forwards the video data to the smartphone, which simultaneously sends acknowledgment packets back to confirm successful reception. This ongoing communication ensures smooth playback without interruptions via the first link of the smartphone. During traffic exchange, if the primary link fails or experiences temporary degradation, the process 600 may utilize the second link to serve traffic. The process 600 can also utilize the second link to serve traffic to enhance the performance of the first link.

In one or more embodiments, the process 600 may indicate to the AP that the second link is in a power save mode (block 630). For example, if the process 600 detects a requirement to perform a scan for a roaming candidate AP, the process 600 may indicate to the AP that the second link is temporary unavailable due to the power save mode, and free up the second set of radio resources of the second link for such a scan. For example, the power save mode in a multi-link operation may allow the non-AP MLD to temporarily reduce operation from multiple links to a reduced number of links (e.g., a single link) to conserve power. In such scenario, process 600 may notify the associated AP of such change in link operation, indicating temporary unavailability of the second link.

In various embodiments, the process 600 may scan, upon indicating to the AP that the second link is in the power save mode, for a roaming candidate AP using the second set of radio resources of the second link, while concurrently having the first link operational to exchange traffic with the AP (block 640). In other words, using the multi-link communication interface, the process 600 may opportunistically scan for roaming candidate APs utilizing the second set of radio resources corresponding to the second link (e.g., a secondary link) while maintaining active traffic exchange on the first link.

In additional embodiments, the process 600 may transition an association from the AP to the roaming candidate AP (block 650). Thus, if a superior roaming candidate AP is identified during the scan, the process 600 may transition the association of the non-AP MLD with the current AP to the new superior roaming candidate AP. The transition may be handled seamlessly, ensuring minimal disruption to active traffic. The multi-link communication interface may enable a smooth handoff by maintaining connectivity on the first link until the new roaming candidate AP association is finalized. This step is optional and performed only if a better AP is found to improve connectivity.

Although specific embodiments for enhancing roaming performance with multi-link operation are described above with respect to FIG. 6, any of a variety of systems and/or processes may be utilized in accordance with embodiments of the disclosure. In a still further embodiments, the process 600 may maintain simultaneous associations with multiple APs, dynamically balancing traffic and scanning without interrupting ongoing communication. The elements depicted in FIG. 6 may also be interchangeable with other elements of FIG. 1-5 and FIG. 7-9 as required to realize a particularly desired embodiment.

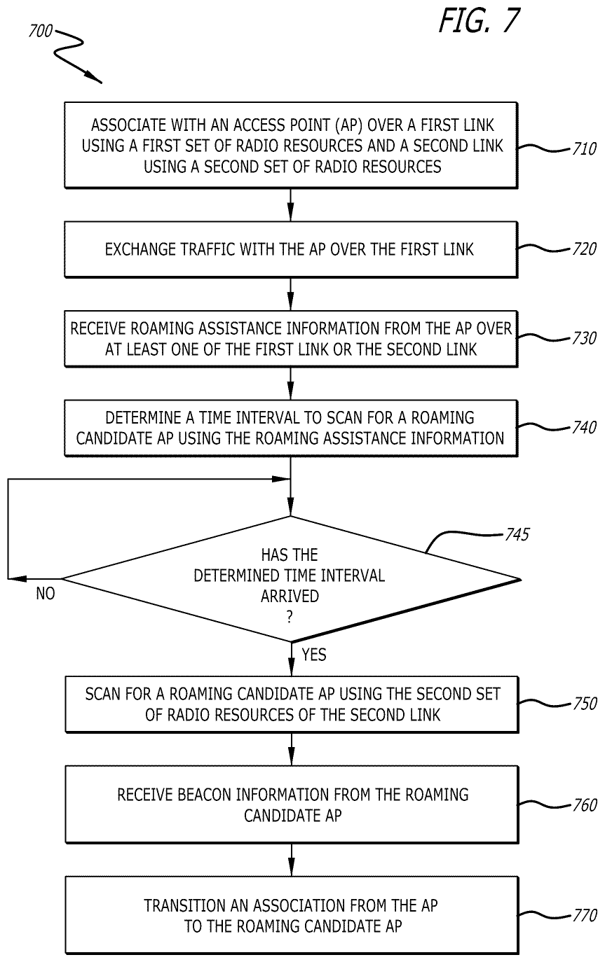

Referring to FIG. 7, a flowchart depicting a process 700 for enhancing roaming performance with multi-link operation in accordance with various embodiments of the disclosure is shown. The process 700 may be performed at a non-AP MLD (e.g., smartphone, laptop, or the like) in a network. In many embodiments, the process 700 may associate with an AP over a first link using a first set of radio resources and a second link using a second set of radio resources (block 710). The process 700 may involve multiple stages such as discovery, authentication, and finally association. The first link established between the AP and the MLD may become the primary communication channel for exchange of traffic. In various embodiments, in a multi-link connection, association between the AP and the non-AP MLD may occur over multiple links, with one link designated as the primary link (e.g., the first link) to handle control frames, management tasks, and essential traffic coordination, while other links (e.g., the second link) may serve as secondary links, providing additional bandwidth, improved performance, or acting as backups to maintain connectivity in case of primary link failure.

In a variety of embodiments, the process 700 may exchange traffic with the AP over the first link (block 720). After successfully associating with the AP, the process 700 may exchange traffic over the associated first link. Exchanging the traffic over the first link may include different network activities such as web browsing, video streaming, file transfers, voice over internet protocol (VoIP) calls, or even reception of roaming assistance information. The first link may maintain continuous communication between non-AP MLD and the AP to provide an uninterrupted user experience. Any communication initiated by the non-AP MLD may be routed through the first link that may serve as the primary link.

In a number of embodiments, the process 700 may receive roaming assistance information from the AP over at least one of the first link or the second link (block 730). The roaming assistance information may be transmitted by the AP to facilitate efficient handoffs to nearby APs when necessary. The roaming assistance information may provide the process 700 with network guidance, such as preferred APs for roaming (e.g., roaming candidate APs), channels, or bands, to enable faster and more efficient transitions between APs during roaming and to avoid reactive panic behavior. Accordingly, the roaming assistance information may include a neighbor report, an RNR, or a link measurement report. In more embodiments, the roaming assistance information may be received in one or more information elements of a wireless frame, such as a BTM request frame or a link reconfiguration notify frame. The wireless frame can be a beacon frame or a probe response frame. The roaming assistance information may further indicates at least one neighbor AP of the AP. Among the one or more information elements in the wireless frame, at least one information element may be configured to indicate beacon transmission times of the neighbor AP(s) of the currently associated AP. In still more embodiments, beacon transmission times may include a Target Beacon Transmission Time (TBTT) offset of each neighbor AP. TBTT of a neighbor AP may indicate time difference between a currently associated AP's beacon transmission and a neighbor AP's beacon transmission.

In further embodiments, the process 700 may determine a time interval to scan for a roaming candidate AP using the roaming assistance information (block 740). For example, the process 700 may determine at least one time interval during which the process 700 may schedule a roaming candidate AP scan. The at least one time interval may be aligned with the beacon transmission of a neighbor AP as indicated in the roaming assistance information. For example, based on the TBTT offset provided for a neighbor AP, the process 700 may determine that the non-AP MLD shall scan for that neighbor AP's beacon at precisely 10:15:00 AM. This timing ensures that the non-AP MLD captures or intercepts beacon information of the neighbor AP without delays, reducing scanning overhead.

In several embodiments, the process 700 may monitor whether the determined time interval has arrived (block 745). The process 700 may monitor the current time and wait for the determined time interval to arrive. During this waiting period, the process 700 may continue normal traffic exchange on the first link and (optionally or alternatively) the second link to avoid service interruptions. For example, the determined time interval may be 10:15:00 AM and the current time may be 10:14:30 AM. In such a scenario, the process 700 may determine that the determined time interval has not arrived yet and may continue monitoring (block 745).

However, in numerous embodiments, if the determined time interval has arrived, the process 700 may scan for the roaming candidate AP using the second set of radio resources of the second link (block 750). At the determined time interval, the process 700 may indicate to the AP that the second link is unavailable and then repurpose the second set of radio resources of the second link to scan for the roaming candidate AP. The scanning operation may be performed concurrently without disrupting traffic on the first link in MLMR communication interfaces. The process 700 may listen for beacon frames from the roaming candidate AP and evaluate the signal strength, load, and other parameters to identify the best roaming candidate. In many additional embodiments, the second set of radio resources associated with the second link 418 can be utilized to scan the first and second roaming candidate APs across any channel or band. In many further embodiments, if the second link operates on the 5 GHz band, and the process 700 indicates (or signals) the power saving mode for the second link to the AP, the second set of radio resources associated with the second link can be repurposed to perform scans on any 5 GHz channels or even channels in other frequency bands, such as the 6 GHz band, provided the second set of radio resources supports operation in those bands.

In further additional embodiments, the process 700 may receive beacon information from the roaming candidate AP (block 760). That is to say, during the scan, the process 700 may listen for beacon frames transmitted by the roaming candidate AP. The beacon frames provide essential information, including the SSID, channel, security capabilities, and load associated with the roaming candidate AP. This information may allow the process 700 to make an informed decision about whether to switch to the roaming candidate AP or remain connected to the current AP.

In several additional embodiments, the process 700 may transition the association from the AP to the roaming candidate AP (block 770). If the roaming candidate AP is identified as better than the current AP (e.g., stronger signal, lower load), the process 700 may initiate a handoff. The handoff may involve de-associating from the current AP and associating with the roaming candidate AP. In one or more embodiments, de-associating from the current AP and associating with the roaming candidate AP may be optional.

Although a specific embodiment for enhancing roaming performance with multi-link operation suitable for carrying out the various steps, processes, methods, and operations described herein is discussed with respect to FIG. 7, any of a variety of systems and/or processes may be utilized in accordance with embodiments of the disclosure. For example, although the scanning process is illustrated using radio resources of a single secondary link, the process 700 may involve simultaneous scanning for roaming candidate APs using radio resources of multiple secondary links. These scans can occur concurrently with traffic exchange in the first link. The elements depicted in FIG. 7 may also be interchangeable with other elements of FIG. 1-6, 8, and 9 as required to realize a particularly desired embodiment

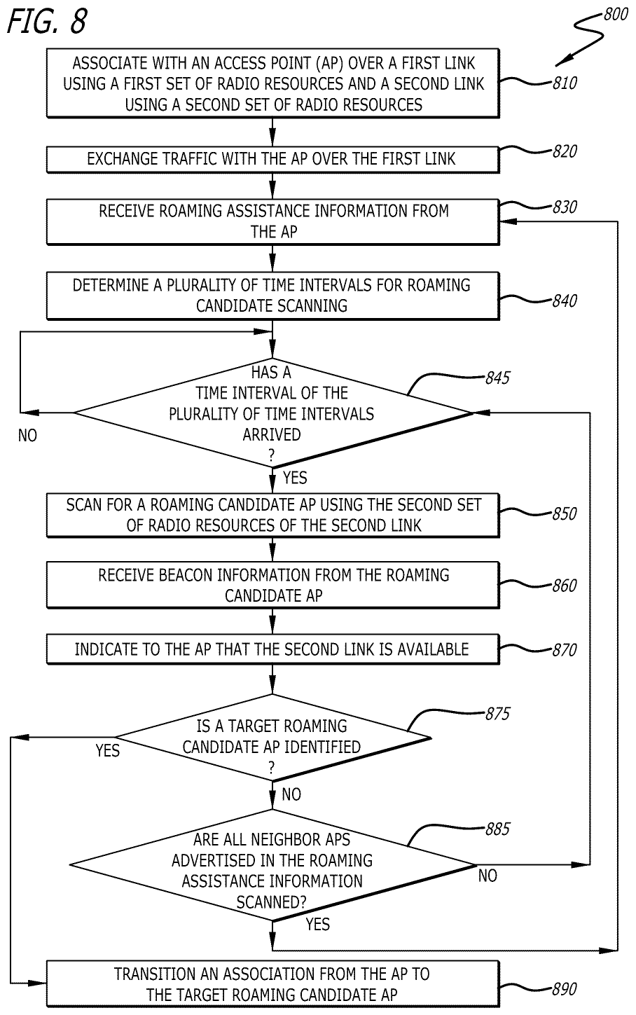

Referring to FIG. 8, a flowchart depicting a process 800 for multi-link scanning for roaming candidate APs in accordance with various embodiments of the disclosure is shown. The process 800 may be performed at a non-AP MLD. In many embodiments, the process 800 may associate with an AP over a first link using a first set of radio resources and a second link using a second set of radio resources (block 810). The process 800 may enable the non-AP MLD to establish a connection with a selected AP via the first link and the second link after discovering the network of the AP, authenticating, and completing the association process. The first link may therefore act as a primary link and the second link may act as a secondary link. In various embodiments, in a multi-link connection, association between the AP and the non-AP MLD may occur over multiple links, with one link designated as the primary link (e.g., the first link) to handle control frames, management tasks, and essential traffic coordination, while other links (e.g., the second link) may serve as secondary links, providing additional bandwidth, improved performance, or acting as backups to maintain connectivity in case of primary link failure.

In a variety of embodiments, the process 800 may exchange traffic with the AP over the first link (block 820). Once connected, the process 800 may utilize the first link to send and receive data. In other words, the first link may handle all regular network activities, like streaming, downloading, or web browsing, ensuring uninterrupted communication with the AP. During traffic exchange, if the primary link fails or experiences temporary degradation, the process 800 may utilize the second link to serve traffic. The process 800 can also utilize the second link to serve traffic to enhance the performance of the first link.

In a number of embodiments, the process 800 may receive roaming assistance information from the AP (block 830). In other words, the traffic exchange between the AP and the non-AP MLD may also include roaming assistance information received over at least one of the first link or the second link, for example. The roaming assistance information may include details about nearby APs provided through neighbor reports, RNRs, or a link measurement reports. The process 800 may receive the roaming assistance information in one or more information elements of a wireless frame, such as a BTM request frame, a link reconfiguration notify frame, or the like. The roaming assistance information may be received through beacon frames or probe response frames, and may indicate at least one neighbor AP of the AP.

In numerous embodiments, the process 800 may determine a plurality of time intervals for roaming candidate scanning (block 840). The plurality of time intervals may be determined based on the roaming assistance information. For example, at least one of the information elements in the received wireless frame may include TBTT offset values corresponding to multiple neighbor APs of the AP associated with the non-AP MLD. A TBTT offset may indicate a time difference between the current AP's beacon transmission and a roaming candidate AP's beacon transmission. Using the TBTT offset values, the process 800 may determine the plurality of time intervals during which the non-AP MLD can efficiently scan for roaming candidate APs.

In several embodiments, the process 800 may determine whether a time interval of the plurality of time intervals has arrived (block 845). The process 800 may monitor the current time and wait for at least one of the determined time intervals to arrive. During this period, the exchange of traffic between the currently associated AP and the non-AP MLD may continue. In several additional embodiments, if a time interval of the plurality of time intervals has not arrived, the process 800 may continue to wait (block 845).

However, if the time interval of the plurality of time intervals has arrived, in numerous embodiments, the process 800 may scan for a roaming candidate AP utilizing the second set of radio resources of the second link (block 850). Therefore, at the scheduled time interval, the process 800 may indicate to the AP that the second link is unavailable (for example, unavailable due to being in a power save mode or congested) and then repurpose the second set of radio resources of the second link to scan for the neighbor AP. The scan may be performed concurrently without interrupting the traffic on the first link, enabling the non-AP MLD to identify potential APs for roaming. For example, at 10:10 AM, the non-AP MLD may scan by utilizing the second set of radio resources corresponding to the second link and detect a neighbor AP operating on a channel with sufficient signal strength.

In several additional embodiments, the process 800 may receive beacon information from the roaming candidate AP (block 860). The beacon information may provide important information like signal strength, load, and other parameters, which help the MLD to evaluate the suitability of the roaming candidate AP over other roaming candidate APs and the current AP as well. The beacon information can be received concurrently while traffic is also simultaneously exchanged on the first link.

In further additional embodiments, the process 800 may indicate to the AP that the second link is available (block 870). That is to say, after receiving sufficient beacon information or completing a scan cycle, the process 800 may stop scanning and resume normal operation with the AP on the second link. This ensures efficient resource utilization and prevents unnecessary scanning. For example, once the non-AP MLD captures beacon information from the neighbor AP, the non-AP MLD may halt the scanning process until the next scanning time interval arrives.

In numerous additional embodiments, the process 800 may determine whether a target roaming candidate AP is identified (block 875). That is to say, the process 800 may evaluate the scanned roaming candidate APs based on the received beacon information to determine if a suitable roaming candidate AP exists. The non-AP MLD may compare the signal strength, load, and operating channels of scanned roaming candidate APs to identify the best candidate. If no roaming candidate AP meets the criteria, the process 800 may continue scanning.

In many further embodiments, if the target roaming candidate AP is not identified, the process 800 may check whether all neighbor APs advertised in the roaming assistance information have been scanned (block 885). If the non-AP MLD has not scanned all the roaming candidate APs listed or advertised in the roaming assistance information, the process 800 may wait for the next scheduled time interval for scanning remaining roaming candidate APs (block 845). For example, the non-AP MLD has scanned three out of five advertised roaming candidate APs, the non-AP MLD wait to scan the remaining two roaming candidate APs. However, if all the roaming candidate APs listed or advertised are scanned and no target roaming candidate AP is identified, the process 800 may wait to receive new roaming assistance information (block 830).

However, if the target roaming candidate AP is identified, in still more embodiments, the process 800 may transition the association from the AP to the target roaming candidate AP (block 890). After evaluating the nearby roaming candidate APs, the non-AP MLD may first de-associate from the current AP by transmitting a dissociation message. The MLD may then be configured to connect to the identified target roaming candidate AP that may provide with better signal strength and lower latency.

Although a specific embodiment for multi-link scanning for roaming candidate APs suitable for carrying out the various steps, processes, methods, and operations described herein is discussed with respect to FIG. 8, any of a variety of systems and/or processes may be utilized in accordance with embodiments of the disclosure. As one of ordinary skill in the art will readily recognize, the examples and technologies provided above are simply for clarity and explanation purposes and can include many additional concepts and variations. For example, scanning for roaming candidate APs may be proactive approach, where the transition of association is optional and only triggered when current connection becomes unstable or quality of service of the current connection degrades. The elements depicted in FIG. 8 may also be interchangeable with other elements of FIG. 1-7, and 9 as required to realize a particularly desired embodiment.

Referring to FIG. 9, a conceptual block diagram of a device 900 suitable for configuration with a roaming management logic, in accordance with various embodiments of the disclosure is shown. The embodiment of the conceptual block diagram depicted in FIG. 9 can illustrate a conventional server, computer, workstation, desktop computer, laptop, tablet, network appliance, e-reader, smartphone, or other computing device, and can be utilized to execute any of the application and/or logic components presented herein. The embodiment of the conceptual block diagram depicted in FIG. 9 can also illustrate an access point, a switch, or a router in accordance with various embodiments of the disclosure. The device 900 may, in many nonlimiting examples, correspond to physical devices or to virtual resources described herein.

In many embodiments, the device 900 may include an environment 902 such as a baseboard or “motherboard,” in physical embodiments that can be configured as a printed circuit board with a multitude of components or devices connected by way of a system bus or other electrical communication paths. Conceptually, in virtualized embodiments, the environment 902 may be a virtual environment that encompasses and executes the remaining components and resources of the device 900. In more embodiments, one or more processors 904, such as, but not limited to, central processing units (“CPUs”) can be configured to operate in conjunction with a chipset 906. The processor(s) 904 can be standard programmable CPUs that perform arithmetic and logical operations necessary for the operation of the device 900.

In a number of embodiments, the processor(s) 904 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 906 may provide an interface between the processor(s) 904 and the remainder of the components and devices within the environment 902. The chipset 906 can provide an interface to a random-access memory (“RAM”) 908, which can be used as the main memory in the device 900 in some embodiments. The chipset 906 can further be configured to provide an interface to a computer-readable storage medium such as a read-only memory (“ROM”) 910 or non-volatile RAM (“NVRAM”) for storing basic routines that can help with various tasks such as, but not limited to, starting up the device 900 and/or transferring information between the various components and devices. The ROM 910 or NVRAM can also store other application components necessary for the operation of the device 900 in accordance with various embodiments described herein.

Additional embodiments of the device 900 can be configured to operate in a networked environment using logical connections to remote computing devices and computer systems through a network, such as the network 940. The chipset 906 can include functionality for providing network connectivity through a network interface card (“NIC”) 912 which may comprise a gigabit Ethernet adapter or similar component. The NIC 912 can be capable of connecting the device 900 to other devices over the network 940. It is contemplated that multiple NICs 912 may be present in the device 900, connecting the device to other types of networks and remote systems.

In further embodiments, the device 900 can be connected to a storage 918 that provides non-volatile storage for data accessible by the device 900. The storage 918 can, for instance, store an operating system 920, programs 922 (e.g., applications), roaming assistance data 928, scanning time data 930, and beacon data 932 which are described in greater detail below. The storage 918 can be connected to the environment 902 through a storage controller 914 connected to the chipset 906. In certain embodiments, the storage 918 can consist of one or more physical storage units. The storage controller 914 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 900 can store data within the storage 918 by transforming the physical state of the physical storage units to reflect the information being stored. The specific transformation of physical state can depend on various factors. Examples of such factors can include, but are not limited to, the technology used to implement the physical storage units, whether the storage 918 is characterized as primary or secondary storage, and the like.

In many more embodiments, the device 900 can store information within the storage 918 by issuing instructions through the storage controller 914 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 900 can further read or access information from the storage 918 by detecting the physical states or characteristics of one or more particular locations within the physical storage units.

In addition to the storage 918 described above, the device 900 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 900. In some examples, the operations performed by a cloud computing network, and or any components included therein, may be supported by one or more devices similar to device 900. Stated otherwise, some or all of the operations performed by the cloud computing network, and or any components included therein, may be performed by one or more devices 900 operating in a cloud-based arrangement. By way of example, and not limitation, computer-readable storage media can include volatile and non-volatile, removable and non-removable media implemented in any method or technology.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 918 can store an operating system 920 utilized to control the operation of the device 900. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 918 can store other system or application programs and data utilized by the device 900.

In many additional embodiments, the storage 918 or other computer-readable storage media is encoded with computer-executable instructions which, when loaded into the device 900, may transform it from a general-purpose computing system into a special-purpose computer capable of implementing the embodiments described herein. These computer executable instructions may be stored as program 922 (e.g., an application) and transform the device 900 by specifying how the processor(s) 904 can transition between states, as described above. In some embodiments, the device 900 has access to computer-readable storage media storing computer executable instructions which, when executed by the device 900, perform the various processes described above with regard to FIG. 1-8. In certain embodiments, the device 900 can also include computer-readable storage media having instructions stored thereupon for performing any of the other computer-implemented operations described herein.

In still further embodiments, the device 900 can also include one or more input/output controllers 916 for receiving and processing input from a number of input devices, such as a keyboard, a mouse, a touchpad, a touch screen, an electronic stylus, or other type of input device. Similarly, an input/output controller 916 can be configured to provide output to a display, such as a computer monitor, a flat panel display, a digital projector, a printer, or other type of output device. Those skilled in the art will recognize that the device 900 might not include all of the components shown in FIG. 9 and can include other components that are not explicitly shown in FIG. 9 or might utilize an architecture completely different than that shown in FIG. 9.

As described above, the device 900 may support a virtualization layer, such as one or more virtual resources executing on the device 900. In some examples, the virtualization layer may be supported by a hypervisor that provides one or more virtual machines running on the device 900 to perform functions described herein. The virtualization layer may generally support a virtual resource that performs at least a portion of the techniques described herein.

In many further embodiments, the device 900 may include a roaming management logic 924. The roaming management logic 924 can be configured to perform one or more of the various steps, processes, operations, and/or other methods that are described above. Often, the roaming management logic 924 can be a set of instructions stored within a non-volatile memory that, when executed by the processor(s) 904 can carry out these steps, etc. In numerous embodiments, the roaming management logic 924 may perform various operations related to enhanced roaming performance through multi-link operations. In such embodiments, the roaming management logic 924 may associate with an AP over a first link using a first set of radio resources and a second link using a second set of radio resources, and exchange traffic with the AP over the first link and/or the second link. The roaming management logic 924 may receive roaming assistance information with the help of which the roaming management logic 924 may determine at least one time interval for scanning of a roaming candidate AP utilizing the second set of radio resources corresponding to the second link, while being associated with the AP and exchanging the traffic using the first link.

In various embodiments, the storage 918 can include the roaming assistance data 928. The roaming assistance data 928 may refer to the information provided by an AP to help the device 900 to make efficient roaming decisions. The roaming assistance data 928 may include details about neighbor APs, such as their operating channels, capabilities, load, and TBTT offsets that may be provided in neighbor reports, RNRs, BTM request frames, link reconfiguration notify frames, a link management report, or any frame containing neighbor report or RNR (sub)element(s). The roaming assistance data 928 guide the device 900 in identifying potential candidate APs for association.

In still more embodiments, the storage 918 can include the scanning time data 930. The scanning time data 930 may encompass information gathered during the process of scanning for neighbor APs. The scanning time data 930 may include important parameters such as signal strength, channel availability, SSIDs, and beacon timing. The scanning time data 930 may enable the device 900 to evaluate the suitability of nearby APs for roaming. Efficient collection of the scanning time data 930 may ensure that the device 900 can identify the best possible candidates without excessive channel dwell time or unnecessary active scanning. Further, the scanning time data 930 may include scheduled time intervals for performing roaming candidate AP scanning. For example, the scanning time data 930 may be determined based on the roaming assistance data 928.

In a number of embodiments, the storage 918 can include beacon data 932. The beacon data 932 may refer to information transmitted by APs in their periodic beacon frames. The beacon data 932 may include the AP's SSID, supported operating bands, capabilities, and timing details, such as the TBTT. For roaming purposes, the beacon data 932 may serve as a key input, allowing the device 900 to synchronize its scanning efforts and acquire essential connection parameters without needing additional Probe Request/Response exchanges.

Finally, in numerous additional embodiments, data may be processed into a format usable by a machine-learning model 926 (e.g., feature vectors), and or other pre-processing techniques. The machine-learning (“ML”) model 926 may be any type of ML model, such as supervised models, reinforcement models, and/or unsupervised models. The ML model 926 may include one or more of linear regression models, logistic regression models, decision trees, Naïve Bayes models, neural networks, k-means cluster models, random forest models, and/or other types of ML models 926.

The ML model(s) 926 can be configured to generate inferences to make predictions or draw conclusions from data. An inference can be considered the output of a process of applying a model to new data. This can occur by learning from at least the roaming assistance data 928, the scanning time data 930, and the beacon data 932, and utilize the learning to predict future outcomes. For example, the ML model(s) 926 can be used for predicting a plurality of time intervals for scanning of roaming candidate APs. This may be done by using supervised learning techniques like linear regression or random forests can forecast the plurality of time intervals using historical beacon reception or probe response data. Unsupervised learning methods, such as k-means clustering, can detect hidden patterns in network behavior and resource usage.

To train the ML model, a detailed dataset such as the roaming assistance data 928, the scanning time data 930, and the beacon data 932 can be gathered. Preprocessing and feature extraction may be performed to identify the most important data points. This refined data is used to train the ML/AI model, allowing it to learn relevant patterns. Once trained, the ML model 926 may be integrated into the device 900 to make real-time decisions or predictions based on the association of the device 900 with a particular AP. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 926 may be generated by human/administrator verifications or may compare predicted outcomes with actual outcomes.

Although a specific embodiment for a device suitable for configuration with a roaming management logic for carrying out the various steps, processes, methods, and operations described herein is discussed with respect to FIG. 9, any of a variety of systems and/or processes may be utilized in accordance with embodiments of the disclosure. For example, the device may be in a virtual environment such as a cloud-based network administration suite, or it may be distributed across a variety of network devices or switches. The elements depicted in FIG. 9 may also be interchangeable with other elements of FIG. 1-8 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A multi-link device, comprising:
a processor; and
a memory communicatively coupled to the processor, wherein the memory comprises a roaming management logic that is configured to:
associate with an access point (AP) over a first link using a first set of radio resources and a second link using a second set of radio resources;
exchange traffic with the AP over the first link;
indicate to the AP that the second link is unavailable; and
scan, upon indicating to the AP that the second link is unavailable, for a roaming candidate AP using the second set of radio resources of the second link, while having the first link operational with the AP to exchange the traffic.

2. The multi-link device of claim 1, wherein the roaming management logic is further configured to receive roaming assistance information from the AP over at least one of the first link or the second link, and wherein the roaming assistance information indicates at least one neighbor AP of the AP.

3. The multi-link device of claim 2, wherein the roaming management logic is further configured to scan for the roaming candidate AP, using the second set of radio resources of the second link, based on the roaming assistance information.

4. The multi-link device of claim 2, wherein the roaming assistance information comprises at least one of: a neighbor report, a reduced neighbor report, or a link measurement report.

5. The multi-link device of claim 2, wherein the roaming assistance information is received in one or more information elements of a wireless frame.

6. The multi-link device of claim 5, wherein the wireless frame is a beacon frame.

7. The multi-link device of claim 5, wherein the wireless frame is a probe response frame.

8. The multi-link device of claim 5, wherein the wireless frame is at least one of a Basic Service Set (BSS) Transition Management (BTM) request frame or a link reconfiguration notify frame.

9. The multi-link device of claim 5, wherein at least one information element of the one or more information elements is configured to indicate a beacon transmission time of the at least one neighbor AP.

10. The multi-link device of claim 9, wherein the beacon transmission time comprises a Target Beacon Transmission Time (TBTT) offset of the at least one neighbor AP.

11. The multi-link device of claim 9, wherein the roaming management logic is further configured to determine, based on the beacon transmission time, at least one time interval for roaming candidate scanning.

12. The multi-link device of claim 11, wherein the roaming management logic is further configured to scan for the roaming candidate AP, using the second set of radio resources of the second link, during the determined at least one time interval.

13. The multi-link device of claim 1, wherein the roaming management logic is further configured to receive, based on the scanning, beacon information from the roaming candidate AP.

14. The multi-link device of claim 13, wherein the roaming management logic is further configured to transition an association from the AP to the roaming candidate AP based on the received beacon information.

15. The multi-link device of claim 1, wherein indicating to the AP that the second link is unavailable comprises indicating to the AP that the second link is in a power save mode.

16. A multi-link device, comprising:
a multi-link communication interface comprising a first set of radio resources and a second set of radio resources;
a processor; and
a memory communicatively coupled to the processor, wherein the memory comprises a roaming management logic that is configured to:
associate with an access point (AP) over a first link using the first set of radio resources and a second link using the second set of radio resources;
exchange traffic with the AP over the first link;
indicate to the AP that the second link is unavailable; and
scan, upon indicating to the AP that the second link is unavailable, for a roaming candidate AP using the second set of radio resources of the second link, while concurrently having the first link operational to exchange the traffic with the AP.

17. A method for roaming, comprising:
by a multi-link device:
associating with an access point (AP) over a first link using a first set of radio resources and a second link using a second set of radio resources;
exchanging traffic with the AP over the first link;
indicating to the AP that the second link is in a power save mode; and
scanning, upon indicating to the AP that the second link is in the power save mode, for a roaming candidate AP using the second set of radio resources of the second link, while having the first link operational with the AP to exchange the traffic.

18. The method of claim 17, further comprising receiving roaming assistance information, indicating at least one neighbor AP of the AP, from the AP over at least one of the first link or the second link, wherein the scanning for the roaming candidate AP using the second set of radio resources is based on the roaming assistance information.

19. The method of claim 18, further comprising determining, based on the roaming assistance information, at least one time interval for roaming candidate scanning.

20. The method of claim 19, wherein the scanning for the roaming candidate AP, using the second set of radio resources of the second link, occurs during the determined at least one time interval.
